(19) United States
(12) Patent Application Publication
(10) Pub. No.: US 2004/0056519 A1
(43) Pub. Date: Mar. 25, 2004

(54) Ergonomic bicycle seat with prostate guard

(76) Inventor: Bulent Ibrahim Kastarlak, Palm Beach Gardens, FL (US)

Correspondence Address: Bulent I. Kastarlak, 11 Via Aurelia, Palm Beach Gardens, FL, 33418, US

(21) Appl. No.: 10/251,974

(22) Filed: Sep. 23, 2002

(51) Int. Cl. B62J 1/00

(52) U.S. Cl. 297/195.1

(57) ABSTRACT

Ergonomic Bicycle Seat With Prostate Guard (ERGOSEAT) is an ergonomically designed sitting device for making bicycle riding more comfortable for men and women suffering from loss of blood circulation and loss of sensation at their sexual organs, and from pain at their wrists, as they ride on conventional bicycle seats. The invention creates an air space, Prostate Guard, between the sensitive area of the body and the conventional bicycle seat by eliminating the third forward contact point and by substituting a new contact point, Frontal Support of ERGOSEAT, on lower abdomen. For maintaining proper positioning of the body over the two rear contact points, Bladder Cushions of ERGOSEAT, the Frontal Support arrests forward slide of the body and serves to reduce strain on both arms and wrist. ERGOSEAT is adjustable to fit all body sizes and weights and does not require special details and implements for fastening the Seat to the seat column of the standard bicycle frame.

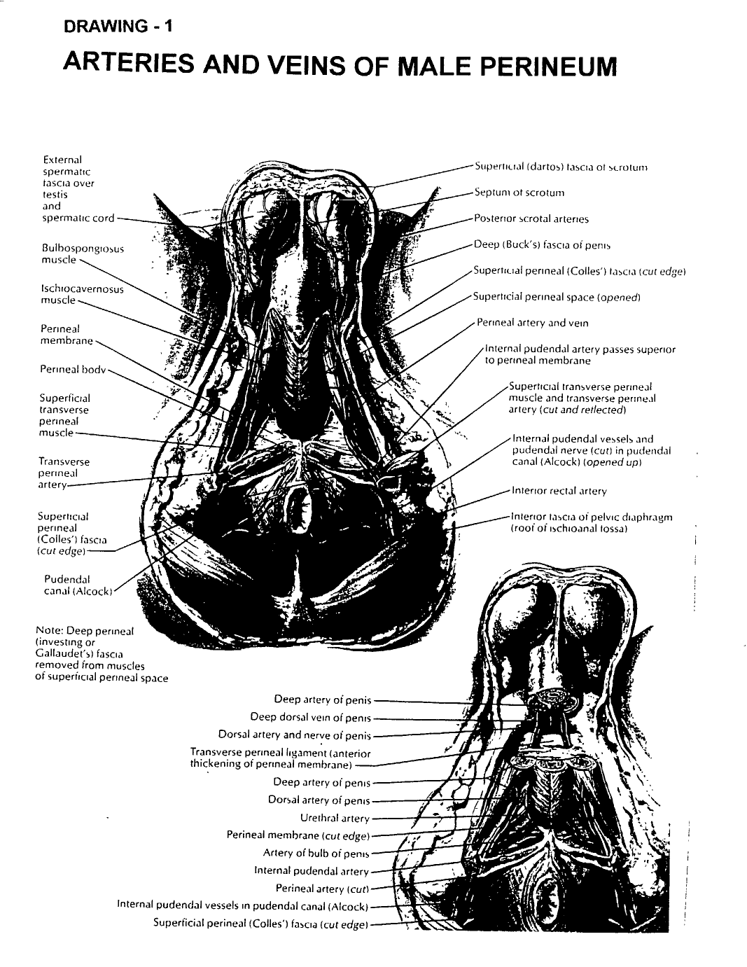

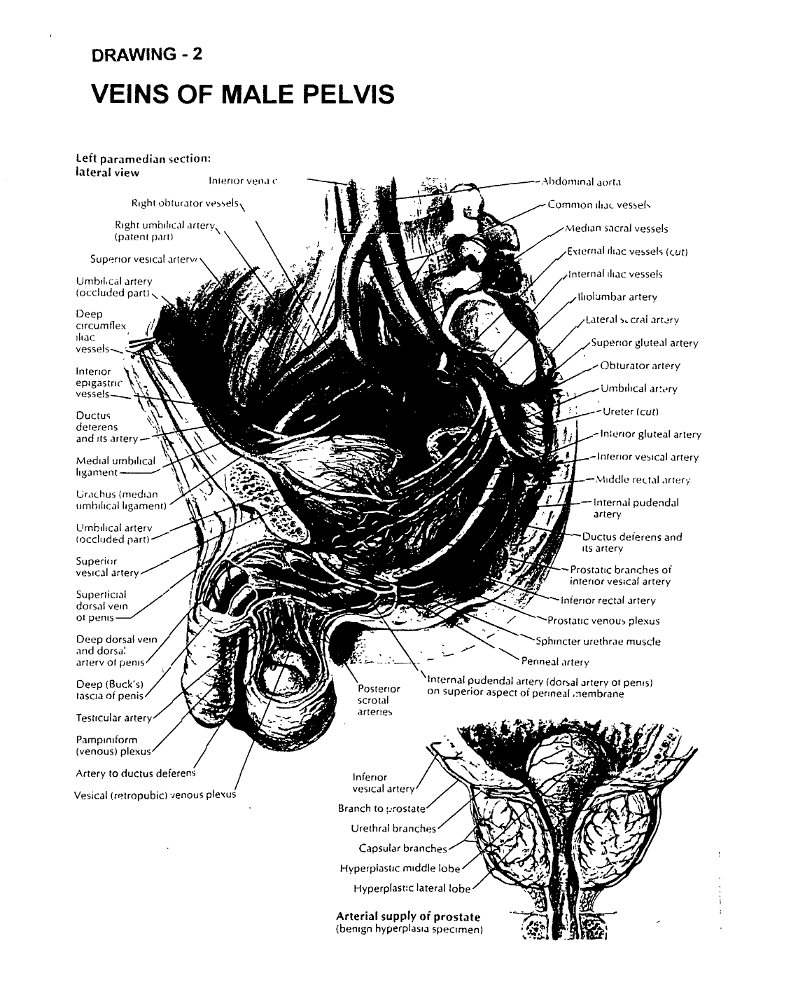

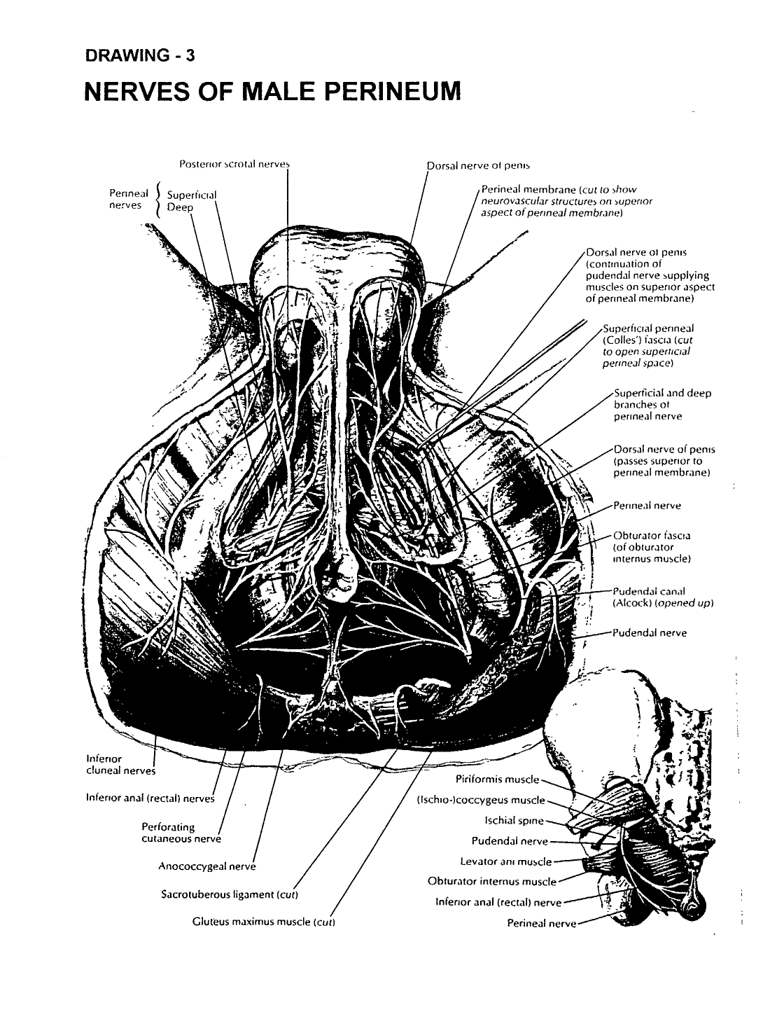

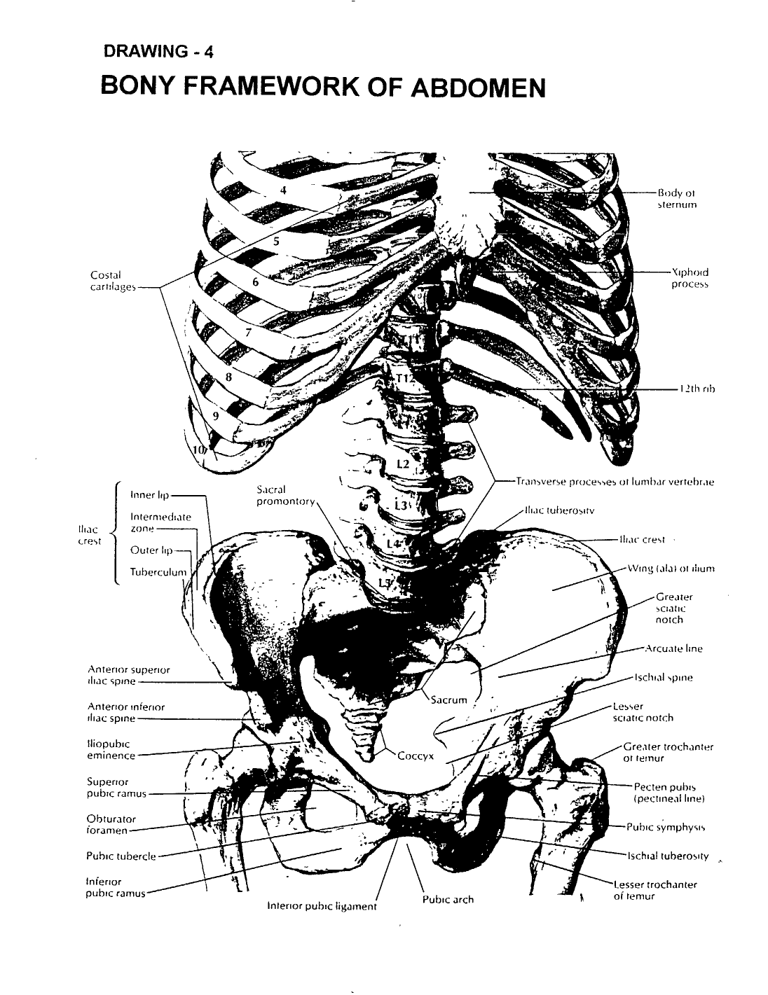

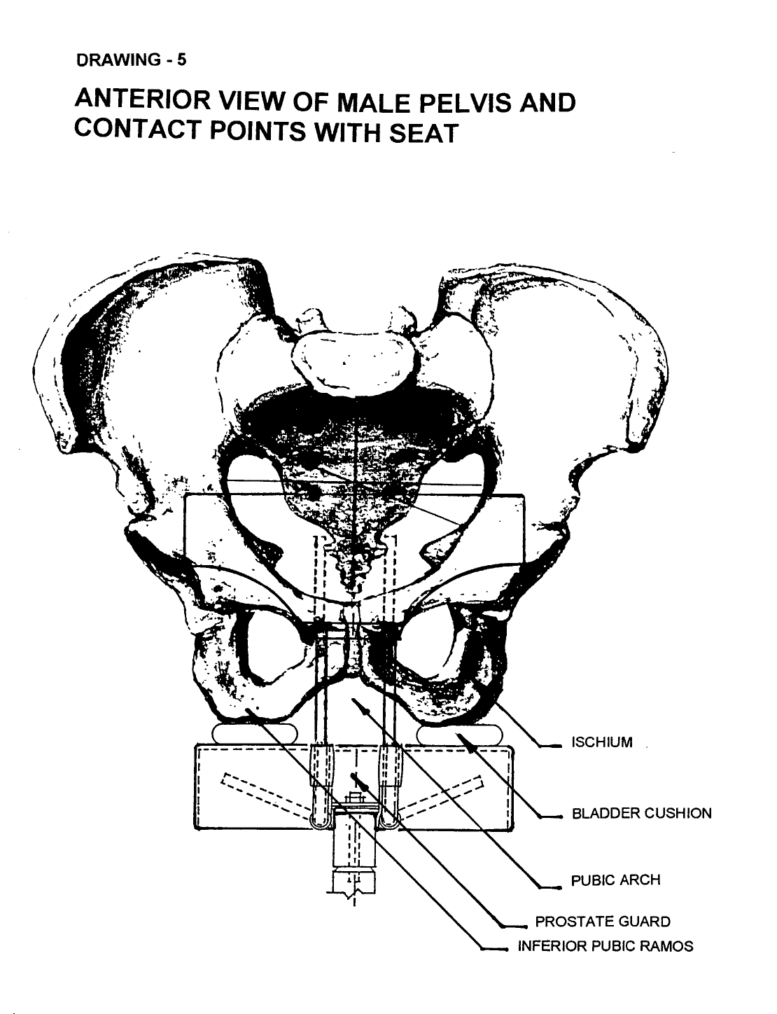

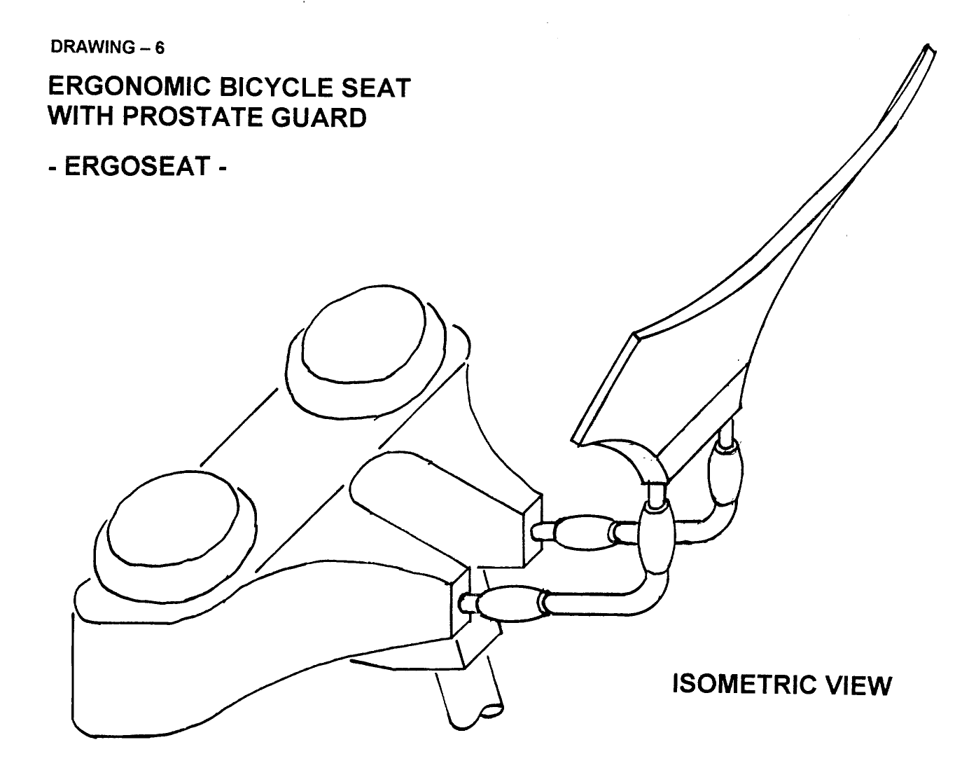

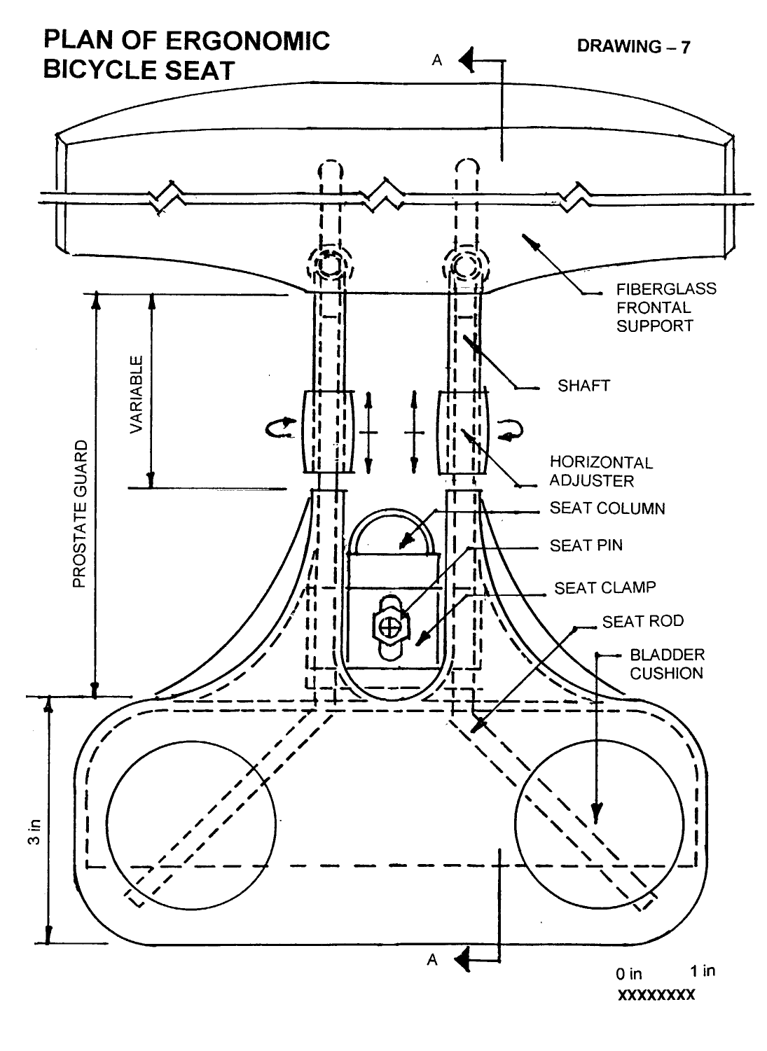

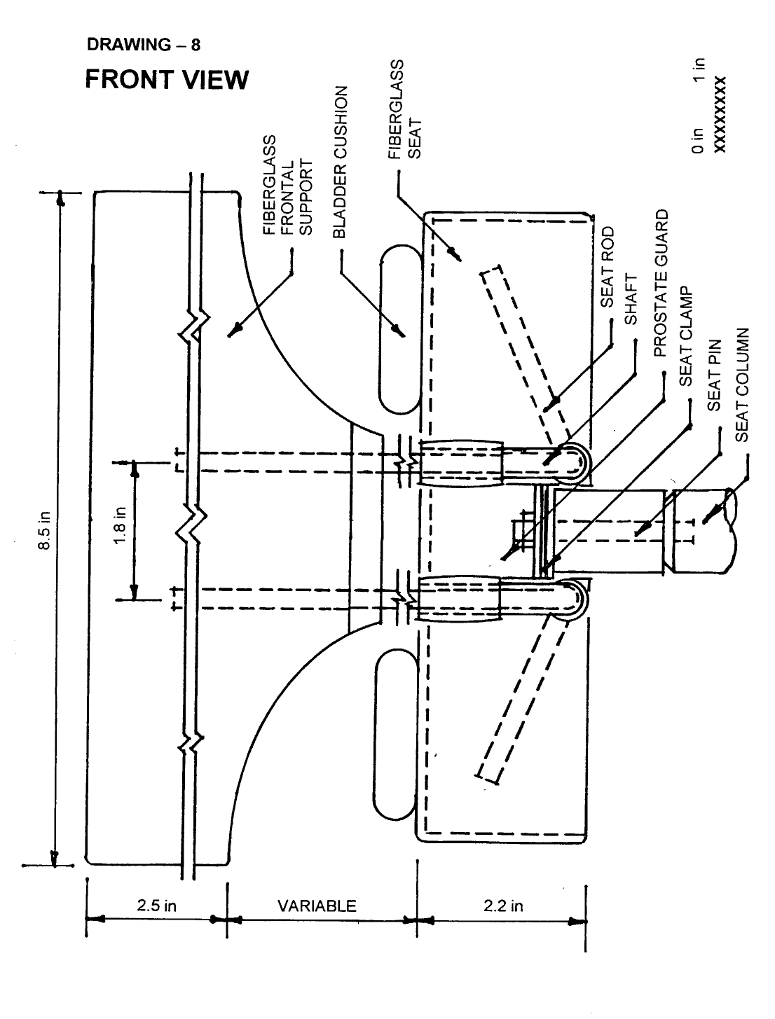

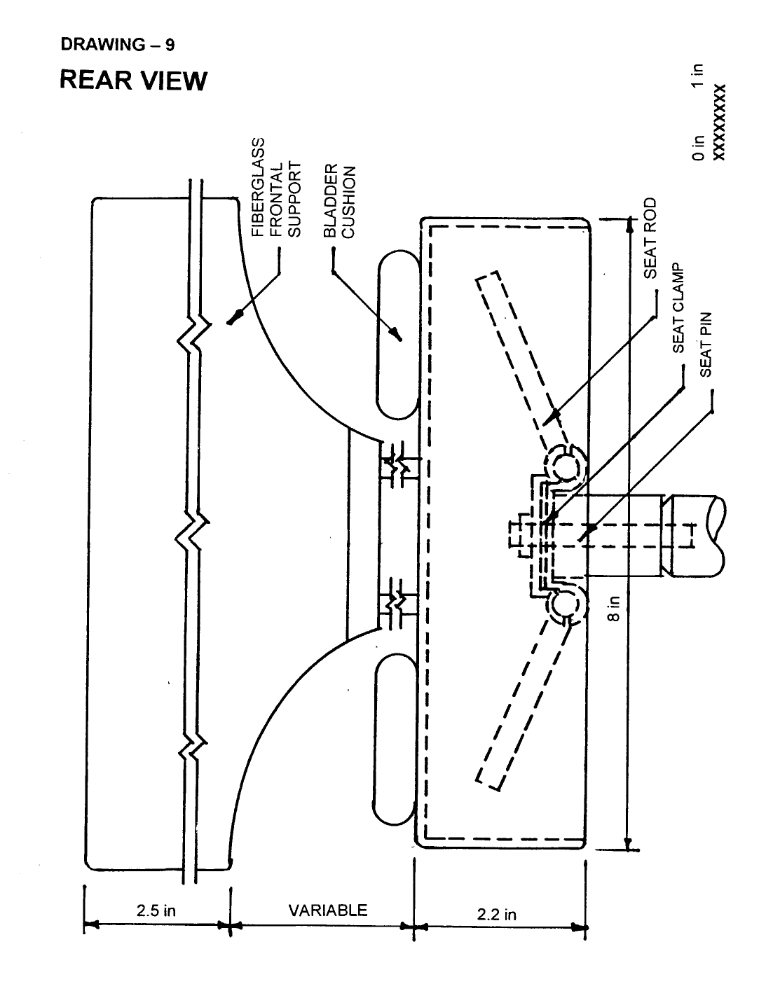

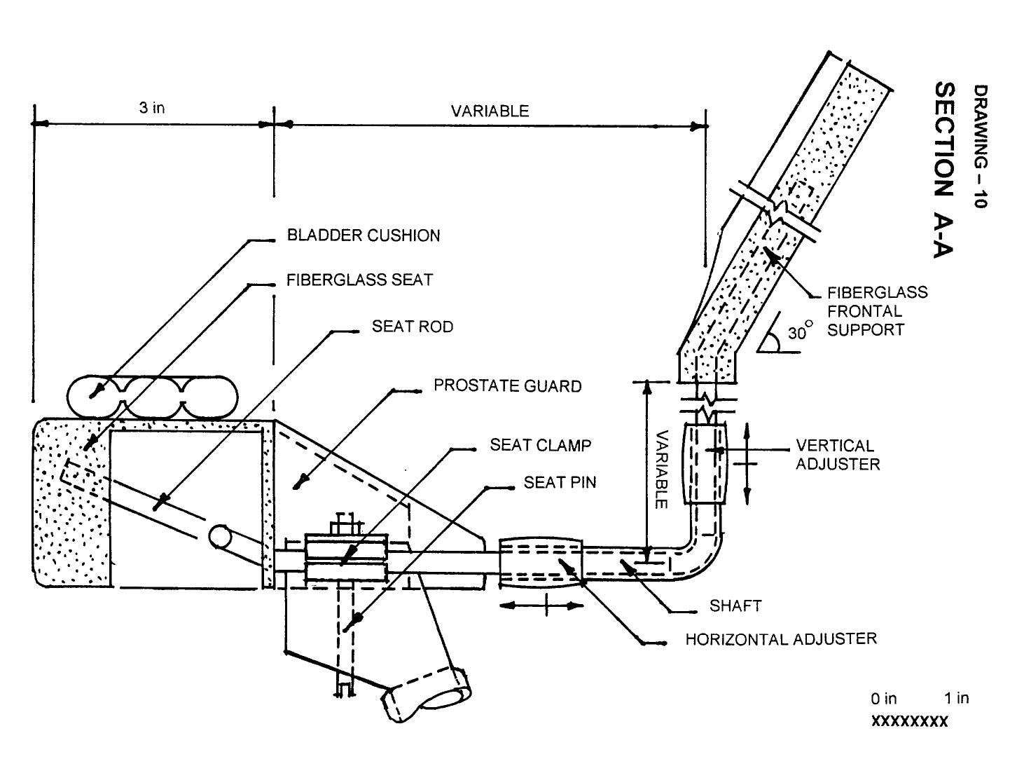

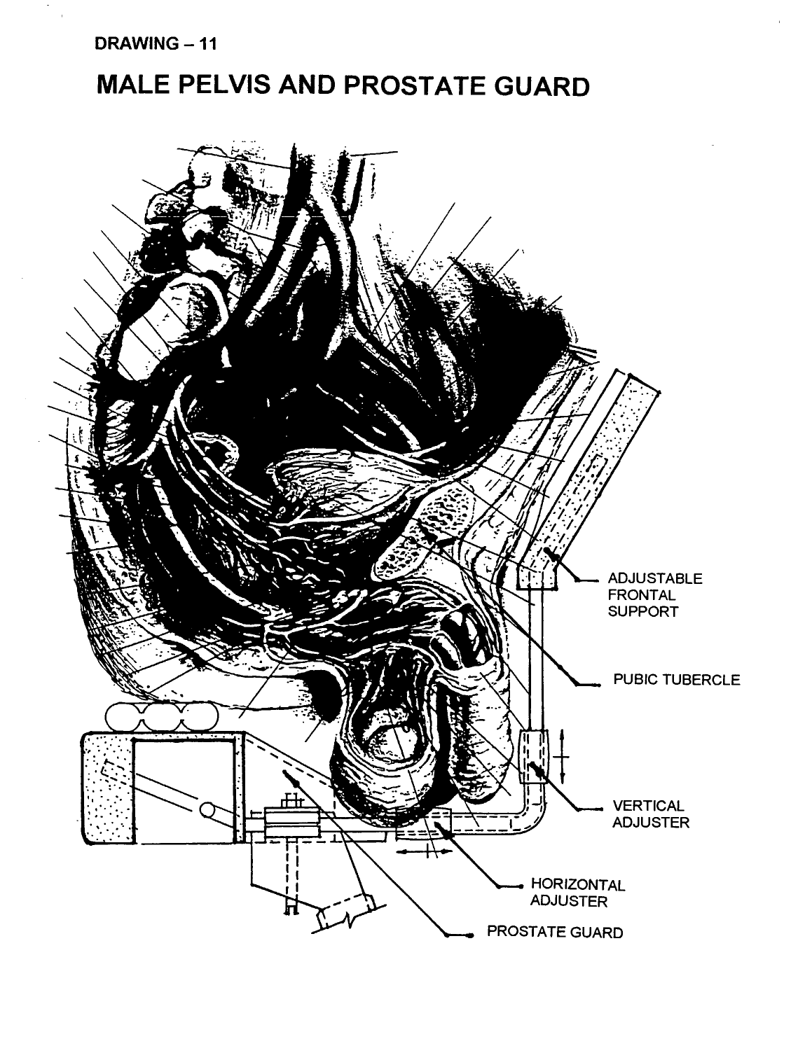

### CROSS REFERENCE TO RELATED APPLICATIONS

This Nonprovisional utility patent application is first of its kind. It does not claim any benefit or relation to one or more prior filed copending Nonprovisional applications, including international applications by the applicant, Bulent I Kastarlak, or, to the best of our knowledge, any other inventor.

### STATEMENT REGARDING FED SPONSORED R&D

The applicant, Bulent I Kastarlak, confirms that his invention was not conceived and developed under any federally sponsored research and development project in which he was a participant or beneficiary.

### REFERENCE TO SEQUENCE LISTING, A TABLE, OR A COMPUTER PROGRAM LISTING APPENDIX

No material or information is submitted separately in the form of a compact disc, program listing, or table, with this application.

### BACKGROUND OF THE INVENTION

The desire to improve certain features of conventional bicycle seats on the market today has prompted the invention. The inventor applicant, Bulent I Kastarlak, has been using bicycles since 1938. As he grew older he has been increasingly subjected to numbing riding experiences caused by blocked blood circulation to male sexual organs and of complete loss of sensation in the Perineum area of the Pelvis. This was combined with discomfort caused by the pressure of the upper body weight on both wrists. He learned that many female riders also complained from their arteries and veins in their Uterus area being blocked after a short ride. After unsuccessfully trying on several bicycle seats made by various manufacturers, and consultation with a urologist, the applicant came to realize that his was not an isolated experience. Although several manufacturers have attempted to overcome this problem by introducing new designs, their designs were not ergonomic and did nor result in substantial improvement of the conditions.

In order to propose a remedy, the inventor applicant, Bulent I Kastarlak, researched the medical literature, in particular the literature on human anatomy. He identified Arteries, Veins, Nerves of male and female Pelvis. He studied the Bony Framework of Abdomen showing the sequence of bones used for transmitting the upper body weight to the seat.

### SUMMARY OF THE INVENTION

The principal problem with bicycle seats on the market today is that the seats are not comfortable to ride on. This condition is particularly true for middle-aged men and women where they may cause physiological changes. In both men and women, temporary stoppage of blood circulation and loss of sensation at sexual organs are particularly troublesome. In medical terms, Perineum and Uterus areas are susceptible to temporary, but at times painful, discomfort. According to medical research, the discomfort may have lasting impact on the health of the Prostate gland in men (Drawings—1,2,3).

The design of proposed invention, Ergonomic Bicycle Seat With Prostate Guard (ERGOSEAT), is such that that the level of discomfort and pain associated with riding a bicycle on a conventional seat, i.e. stoppage of blood circulation to and loss of sensation at sexual organs plus pain on the wrists, will be eliminated (Drawing—6).

The design of ERGOSEAT is new. It has no precedent. (Drawing—7) The principal feature of proposed invention is Prostate Guard. This element of the invention aims to eliminate physical contact between the seat and the forward area of Perineum and Uterus where Arteries, Veins and Nerves are crushed under the weight of the upper body. Another element, Frontal Support, plays a dual role. It maintains the proper position of the upper body over the Bladder Cushions of the Seat by arresting forward sliding of the upper body, and serves to relieve the pressure on the wrists that could cause Carpal Tunnel Syndrome.

### BRIEF DESCRIPTION OF THE DRAWINGS

Several anatomical and engineering drawings are presented. They are referred to in the following text by their titles and Drawing numbers. The purpose of the drawings is to illustrate the elements of the invention and to indicate the interface of the invention with human anatomy. The list of Drawings includes:

Drawing 1—Arteries and Veins of Male Perineum

Drawing 2—Veins of Male Pelvis

Drawing 3—Nerves of Male Perineum

Drawing 4—Bony Framework of Abdomen

Drawing 5—Anterior View of Male Pelvis and Contact Points with Seat

Drawing 6—Ergonomic Bicycle Seat with Prostate Guard—Isometric View

Drawing 7—Plan of Ergonomic Bicycle Seat

Drawing 8—Front View

Drawing 9—Rear View

Drawing 10—Section A-A

Drawing 11—Male Pelvis and Prostate Guard

The drawings are self-explanatory. Suffices to say that as originals they were drawn at two scales. The Isometric View is ½ in=1 in, others are ¾ in=1 in. The bar scales are shown on each engineering drawing. There are no scales for anatomical drawings.

### DETAILED DESCRIPTION OF THE INVENTION

The design of Ergonomic Bicycle Seat With Prostate Guard (ERGOSEAT) is based on observations and empirical tests made on bicycle locomotion and on the interface of the seat with human anatomy. (Drawings—1,2,3,4,5)

The upper body, weighting almost 60% of human body weight, is supported at the bottom largely by the triangular area known as Perineum that interfaces with the triangular shape of a conventional seat.

The weight of the upper body, from head to seat, is transmitted successively by Vertebrae to Pelvic bone or Ilium, to Ischium and finally to Inferior Pubic Ramus on both sides of Ischium where they form two contact points in a conventional seat.

The third contact point with conventional seat occurs at the location of two muscles, Bulbospongiosus and Ischiocavernosus, where Internal Pudental Artery, Perineal Artery and Vein, and Perineal Nerves circulate blood and give sensation to the area. These arteries, veins and nerves reach the muscles after passing through the Pubic Arch of the Pelvic bone.

Both arms and hands transmit a portion of the upper body weight to the handle bar of the bicycle. This weight increases as the body leans forward and may cause Carpal Tunnel Syndrome on both wrists.

With the circular pedaling motion of both legs, and forward slanting seat, the upper body has a tendency to slide forward on the conventional seat. This results in shifting the upper body weight away from the two rear contact points to the front third contact point. In fact, the upper body of bicycle rider is carried largely by the hard protrusion between the two legs of the rider. On a conventional seat this area interfaces with two muscles, several arteries, veins and nerves leading to Scrotum.

The transfer of weight from the two Pubic Ramus bones to the conventional seat changes when the body shifts forward and the bones lose contact with the seat. As a result, greater pressure is exercised over the soft tissues of third contact point. This increased pressure squeezes the Arteries, Veins, and Nerves in the area. Greater body weight pressure on the third contact point causes the stoppage of blood circulation, and loss of sensation, at Prostate, Testis and Penis in males. A similar situation develops at female sexual organs.

Stoppage of blood circulation and loss of sensation is exacerbated as the duration of the bicycle ride gets longer.

ERGOSEAT has the objective of eliminating the third front contact point found on conventional seats (Drawing—6). In place of the third contact point, a 1.5 in wide by 5 in long, by 1.5 in deep air space, to be called Prostate Guard is provided on ERGOSEAT. This key element of ERGOSEAT is for preventing the seat from having direct contact with the Arteries, Veins, Nerves and Muscles of the frontal Perineum area. It will ensure proper blood circulation and sensation during the ride. (Drawing—7)

For transferring the body weight to ERGOSEAT, and for arresting the forward motion of the body while riding, a two-way horizontally and vertically adjustable Frontal Support against the lower abdomen is substituted as the third point of contact. This support will transfer a portion of the body weight from Pubic Tubercle and abdominal muscles to the Seat proper through two adjustable Shafts. Vertical and Horizontal Adjusters will be used to tighten the sliding Shaft into the desired position. By arresting the forward motion with adjustable Frontal Support, the two Inferior Pubic Ramos will be positioned directly above the two soft Bladder Cushions of ERGOSEAT. This will create comfort in riding the bicycle. The wing shape of the adjustable Frontal Support will provide complete freedom for the rotating movement of both legs. (Drawings—8,9)

ERGOSEAT is composed of easy to manufacture components made from simple materials, with simple details. The adjustable Frontal Support and the Seat are made of molded fiberglass plastic. The basic Seat measures at its extremities 5.5 in long, 8 in wide, 2.2 in deep. The Seat is structurally connected to the Seat Column of the bicycle frame by a conventional Pin and Bracket connection. The upper body weight is then transmitted from the Seat to the Seat Column through two Seat Rods. The Seat Rod of ERGOSEAT is a ¼ in steel rod, also used on conventional seats, to carry the seat and to connect it to the Seat Column with a Seat Clamp. ERGOSEAT can be used with any conventional bicycle with a conventional frame. No special equipment, or alteration to a standard bicycle, will be necessary. (Drawing—10,11)

1. What I, Bulent I Kastarlak, claim as my invention is an ergonomically designed (No.1) “Seat” with adjustable elements called—(2) “Prostate Guard”—and—(3) “Frontal Support”—forming together the—(4) “Ergonomic Bicycle Seat with Prostate Guard” (ERGOSEAT). Detailed descriptions of these proprietary elements of my invention are given in Section 3.8.
I, Bulent I Kastarlak, claim (4) “Ergonomic Bicycle Seat with Prostate Guard” (ERGOSEAT) as my most restrictive claim and—(3) “Frontal Support”—(2) “Prostate Guard”—(1) “Seat”—as my progressively least restrictive dependent claims. The dependent claims (3-2-1) refer back to my most restrictive claim (4).
